(19) United States
(12) Patent Application Publication
(10) Pub. No.: US 2010/0117364 A1
(43) Pub. Date: May 13, 2010

(54) BUOYANCY HYDRO POWER GENERATOR AND METHOD

(75) Inventor: Allan Keith Harrigan, Coffs Harbour (AU)

Correspondence Address: KIRTON AND MCCONKIE, 60 EAST SOUTH TEMPLE,, SUITE 1800, SALT LAKE CITY, UT, 84111, US

(73) Assignee: BUOYANCY HYDRO PTY LTD, Coffs Harbour (AU)

(21) Appl. No.: 12/691,579

(22) Filed: Jan. 21, 2010

Related U.S. Application Data
(63) Continuation-in-part of application No. PCT/AU2008/001084, filed on Jul. 28, 2008.

(30) Foreign Application Priority Data
Jul. 30, 2007 (AU) 2007904062
Sep. 12, 2007 (AU) 2007904916
Jan. 4, 2008 (AU) 2008900055

(51) Int. Cl. F03B 13/18; H02K 7/18; F03B 13/00

(52) U.S. Cl. 290/52; 290/53; 290/54

(57) ABSTRACT

A buoyancy hydro power installation comprises wave energy collectors and compressors mounted on a platform at sea level which sits on a vertical tower extending below sea level and houses compressed air pipes, expansion pipes, compressed air storage chambers and a turbine at the submerged end of the tower, said installation being tethered to the sea floor. The wave energy collectors comprise buoyancy tanks mounted on the platform which move up and down with wave motion which drives the air compressors and there are sea current energy collectors comprising turbines which are mounted on the outside of the vertical tower.

### CROSS-REFERENCE TO RELATED APPLICATION

This application is a continuation-in-part of International Application No. PCT/AU2008/001084, filed 28 Jul. 2008.

### FIELD OF THE INVENTION

This invention relates to the controlled generation of electricity from stored energy in response to power demand. The precursor source of energy can be excess off peak electrical power generation or renewable sources of energy such as sea waves and currents, wind or solar.

### BACKGROUND OF THE INVENTION

There are now many installations which harness renewable energy. However the generation of power from renewable sources does not usually match the pattern of demand and there is a need to store energy and use it to generate electrical power with minimum losses during peak demand periods.

There is also a need to store energy generated by conventional coal fired and nuclear power stations since even here it is difficult to match the generation of power with real time demand. One method of storage already used consists of mini hydro installations where excess electrical power is used to pump water to higher levels which is then released through turbines during peak demand.

In the case of harnessing sea energy the motion of waves and currents can vary considerably in short periods of time and this leads to wide fluctuations in power generation which makes a constant voltage and current supply difficult and expensive. One simple method to even out supply resides in storing energy in large fly wheels which tend to even out the fluctuations in movement. However this simple device which has been used historically for example in steam power generation is not adequate for really large fluctuations on the scale of wave and current energy.

The subject invention addresses this problem by utilizing the buoyancy of compressed air at depth in water. One example of this method can be found in JP 2003056459 which discloses a platform floating on the sea surface with wave, wind and solar power generators driving compressors which pump air through pipes extending into the sea below the platform. This compressed air is released into larger pipes which allow expanding air to rise back to the surface together with an induced flow of water up the pipes. This air/induced water flow is then used to drive turbines mounted on the platform which generate electricity.

This design addresses the problem of evening out power generation by storing energy in compressed air tanks below the platform and releasing it at the constant hydrostatic pressure existing at the submerged end of the induced flow pipes. The generator turbines are then driven at a constant speed by the constant induced flow and the required regulated electrical power supply is maintained. However this Japanese design pays a high energy price for the regulated electrical supply since the surface turbines are relatively inefficient.

### OBJECT OF THE INVENTION

It is therefore an object of the present invention to provide buoyancy hydro power storage and generation which improves the supply of electrical power in response to demand or at least provides an alternative method of electrical power storage and generation.

### STATEMENT OF THE INVENTION

According to the present invention a buoyancy hydro power installation comprises wave and/or sea current energy collectors driving air compressors, compressed air pipes taking compressed air to submerged storage chambers, expansion pipes up through which the air is released inducing a flow of water through a turbine chamber and a turbine driven by the induced flow to generate electricity.

Preferably the wave energy collectors and compressors are mounted on a platform at sea level which sits on a vertical tower extending below sea level and houses the compressed air pipes, expansion pipes, compressed air storage chambers and the turbine at the submerged end of the tower, said installation being tethered to the sea floor.

Preferably the compressed air storage chambers are open at the bottom to sea water.

Preferably the wave energy collectors comprise buoyancy tanks mounted on the platform which move up and down relative to the platform with wave motion which drives the air compressors.

Preferably the buoyancy tanks are ballasted with varying amounts of sea water to optimize energy collection from different heights of wave motion.

Preferably the current collectors comprise turbines which are mounted tangential to the outside of the vertical tower.

Preferably the compressed air in the storage chambers is maintained at about 8 atmospheres pressure.

Preferably the bottom of the vertical tower is a minimum of 10 m above the sea bed.

Preferably the electricity generation equipment comprises a generator and a transformer housed on the platform.

Alternatively the generator is integrated with the turbine at the bottom of the tower.

Alternatively a buoyancy hydro power storage installation comprises at least one compressor pumping air into storage, at least one pipe from the storage to the floor of an upright draft tube located in a body of water, through which the air is released inducing a flow of water through a turbine located in the floor of the draft tube to generate electricity.

Preferably compressed air is stored in an underground chamber or a pressure vessel.

Preferably the air is compressed to about 4 atmospheres pressure.

In another form of the invention a method of generating electricity is provided by tethering an installation to the sea bed said installation comprising wave and/or sea current energy collectors driving air compressors, compressed air pipes taking compressed air to submerged storage chambers, expansion pipes up through which the air is released inducing a flow of water through a turbine chamber and a turbine driven by the induced flow to generate electricity.

### BRIEF DESCRIPTION OF THE DRAWINGS

An embodiment of the invention is now described by way of example only with reference to the accompanying drawings in which

FIG. 1 is a perspective view from above of a buoyancy hydro power installation

FIG. 2 is a cross sectioned elevation of an installation

FIG. 3 is a detailed view of a wave energy collector

FIG. 4 is a detailed view of a sea current turbine

FIG. 5 is a detailed view of a sea current mill

FIG. 6 is a schematic showing air and water flows at the top of the installation

FIG. 7 is a schematic showing air and water flows at the bottom of the installation

FIG. 8 is an enlargement of part of FIG. 7 and

FIG. 9 is a schematic showing a land based installation.

### DETAILED DESCRIPTION OF THE INVENTION

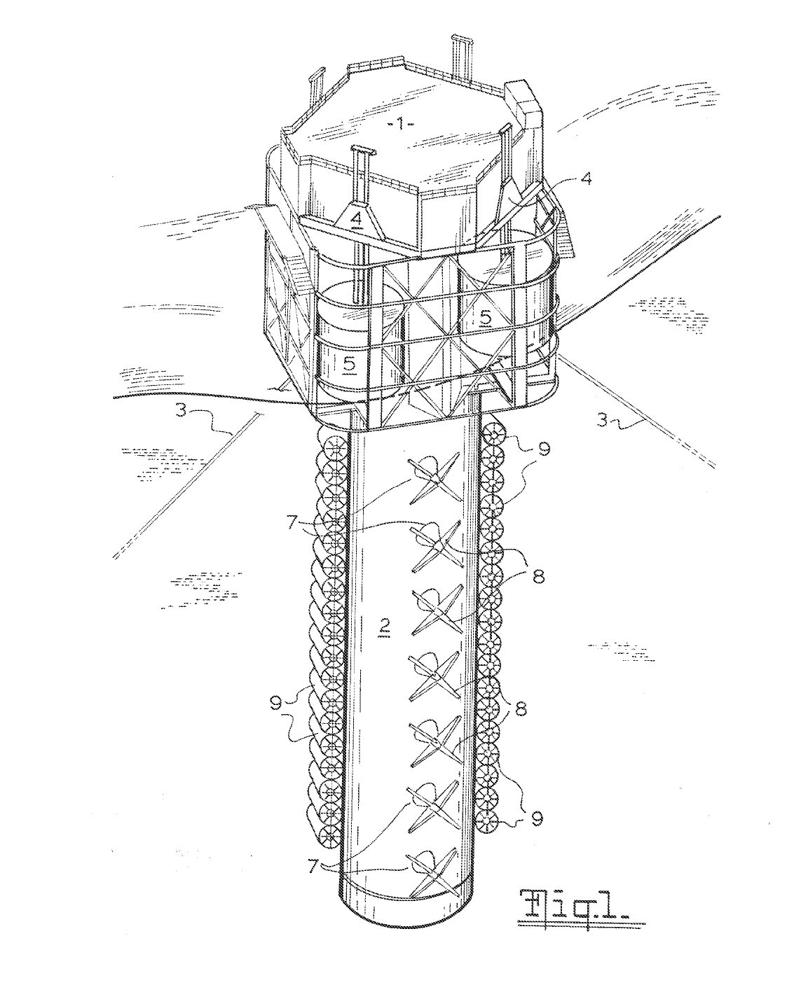

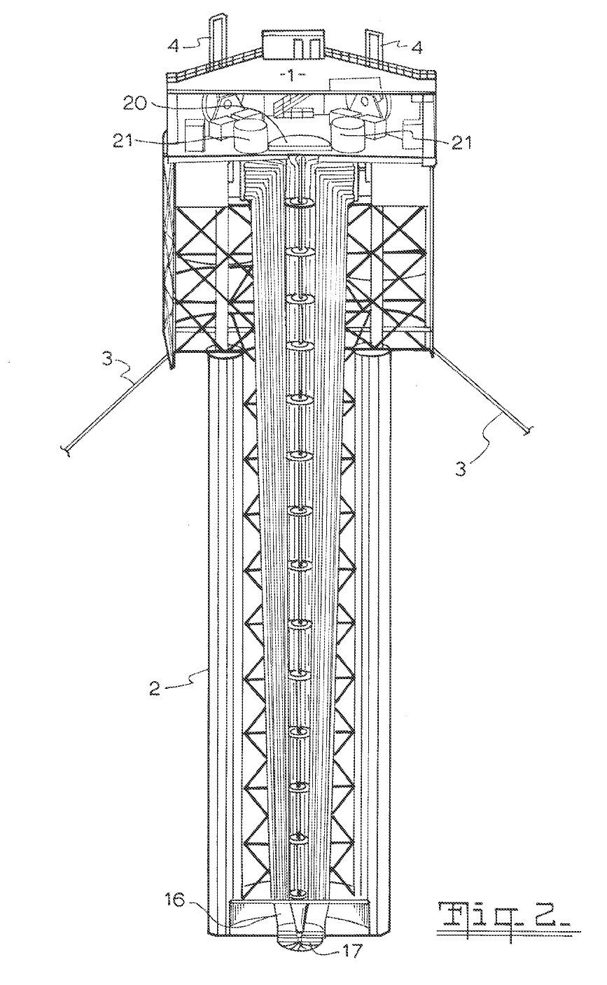

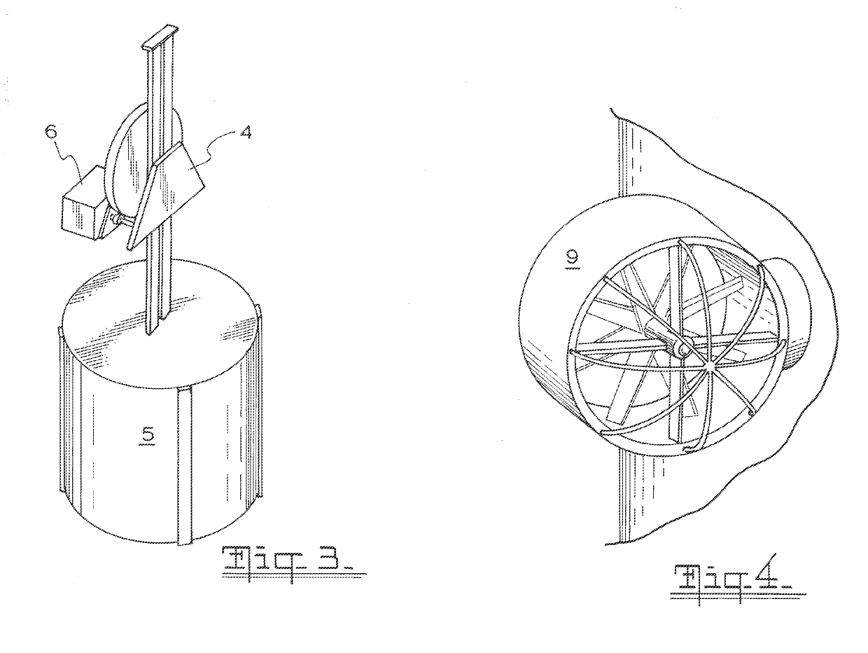

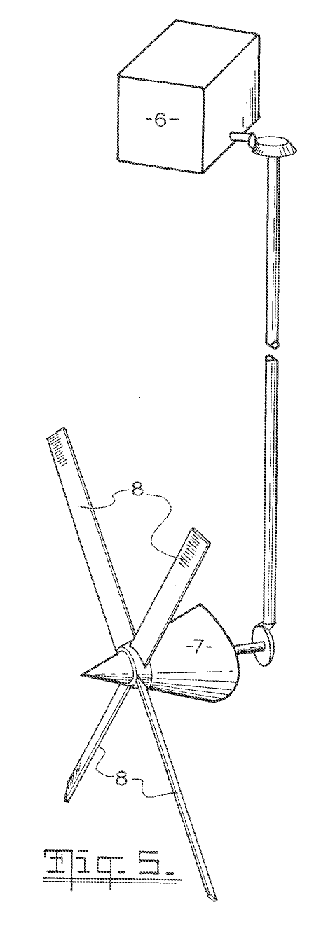

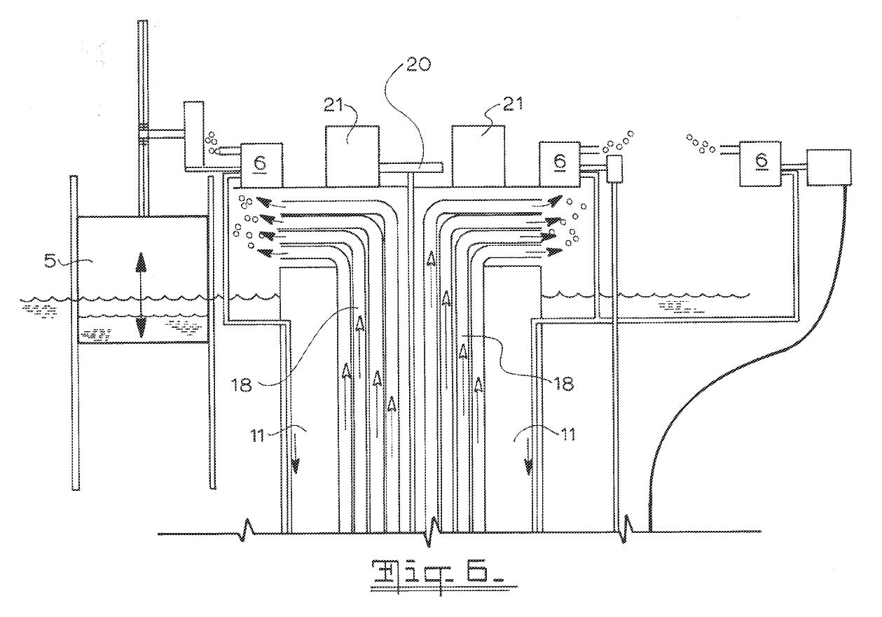

The installation of FIG. 1 comprises a platform 1 mounted on a vertical tower 2 and anchored to the sea bed by cables 3 so that tower 2 is maintained at a constant depth. Platform 1 is partially submerged so that buoyancy tanks 5 of wave energy collectors 4 move up and down with wave motion to drive air compressors 6.

Tanks 5 are ballasted with sea water and are partially submerged to optimize the collection of energy from swells of varying amplitude. For small waves there would only be a small amount of water inside tanks 5, approximately 1 meter, but for larger waves there would be approximately 3 to 4 meters of water to transfer the energy of tanks 5 falling to the compression and tension drives connecting to the flywheel of compressors 6. Sea current mills 7 comprise blades 8 which utilize sea current flows to drive air compressors 6 and current turbines 9 convert sea current flows into hydraulic power which is transferred through hydraulic lines to drive compressors 6.

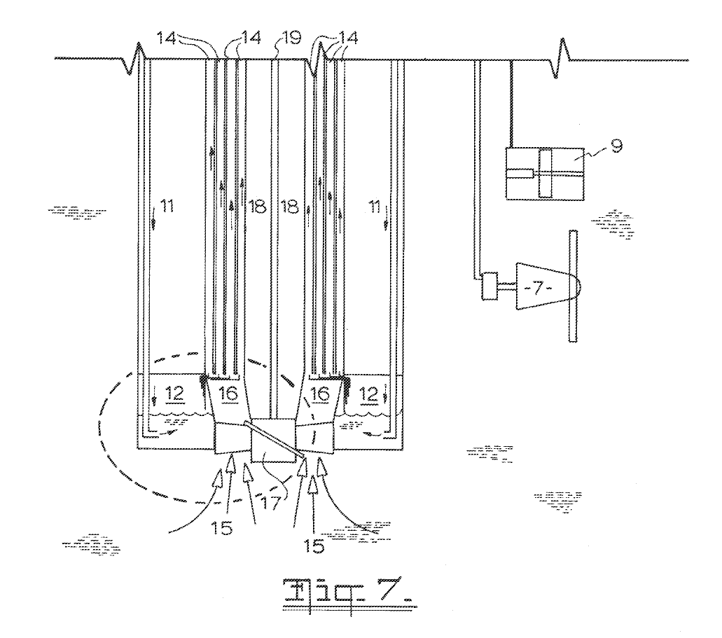

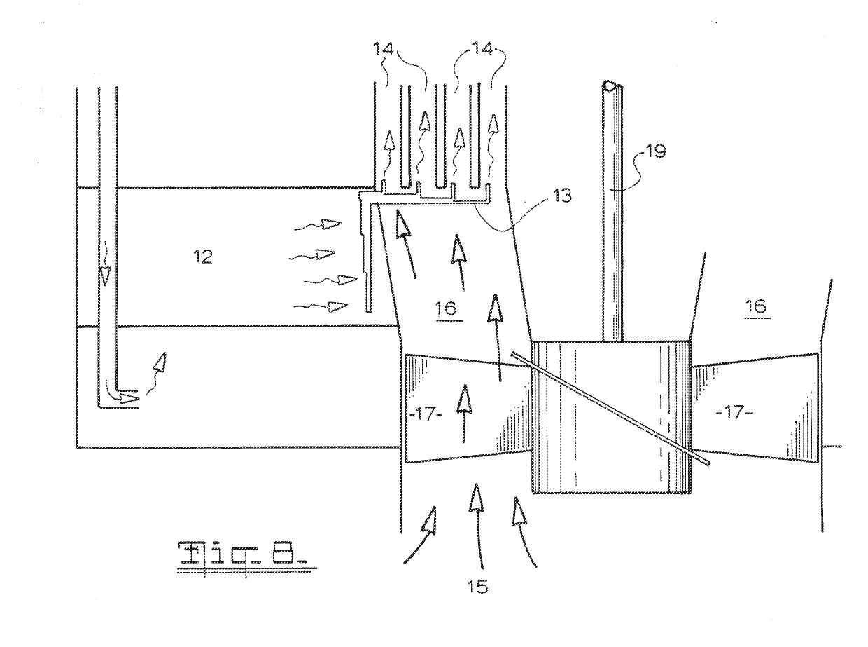

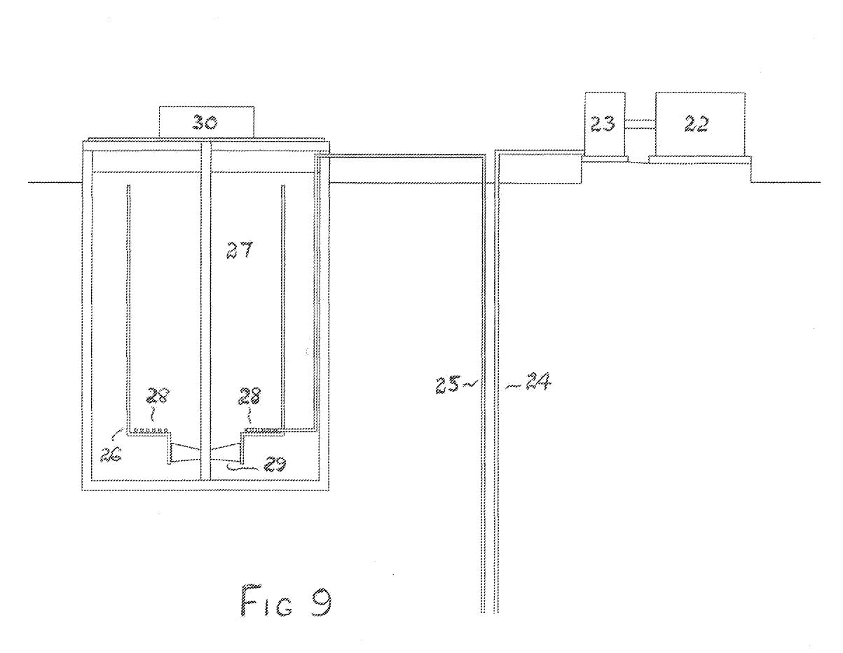

The schematic FIG. 6 shows the energy from collectors 4 and mills 7 driving compressors 6 to produce compressed air streams 11 which feed down to compressed air holding chambers 12 shown in schematic FIGS. 7 and 8. Chambers 12 are open at the bottom to sea water which moves up and down to hold variable amounts of compressed air at a constant hydrostatic pressure which is typically 8 atmospheres. When wave swell and sea currents are weak the volume of compressed air in chambers 12 is depleted and when they are strong the volume is increased to a point where the air escapes through the bottom of chambers 12.

From chambers 12, compressed air is released via injectors 13 into expansion pipes 14 whence it expands and rises inducing a flow 15 of water through the lower opening in turbine chamber 16 which drives turbine blades 17. The air/induced water flows 18 rise up through pipes 14 and are discharged at sea level while turbine shaft 19 drives electrical generator 20. Electrical transformers 21 regulate the electrical power to the required supply for transmission via power cables to land (not shown). In another form of the invention a submersible electrical generator is integrated with the turbine at the bottom of tower 2 thus removing the need for vertical turbine shaft 19.

It is within the scope of the invention to provide a land based buoyancy hydro installation in which compressed air could be released through its turbine to generate electrical power as required. FIG. 9 shows such an installation where electric motor 22 drives compressor 23 which pumps compressed air down pipe 24 to a subterranean chamber such as a disused mine or well. Pipe 25 brings the compressed air back up to the floor of draft tube 26 which is submerged in water filled cavity 27.

The compressed air is released through holes in floor structure 28 creating an induced flow through turbine 29 which drives generator 30. In a typical installation, draft tube 26 is 20 m high and 3 m in diameter while turbine 29 is 0.75 m in diameter. The release pressure of the compressed air through floor structure 27 is about 4 atmospheres.

### VARIATIONS

It will be realised that the foregoing has been given by way of illustrative example only and that all other modifications and variations as would be apparent to persons skilled in the art are deemed to fall within the broad scope and ambit of the invention as herein set forth. For example different size expansion pipes at different depths could produce faster or slower rates of induced water flow with electrical energy outputs of varying current and voltage. Throughout the description and claims of this specification the word “comprise” and variations of that word such as “comprises” and “comprising” are not intended to exclude other additives, components, integers or steps.

1. A buoyancy hydro power installation comprising wave and/or sea current energy collectors driving air compressors, compressed air pipes taking compressed air to submerged storage chambers, expansion pipes up through which the air is released inducing a flow of water through a turbine chamber and a turbine driven by the induced flow to generate electricity.

2. The installation of claim 1 where the wave energy collectors and compressors are mounted on a platform at sea level which sits on a vertical tower extending below sea level and houses the compressed air pipes, expansion pipes, compressed air storage chambers and the turbine at the submerged end of the tower, said installation being anchored to the sea bed.

3. The installation of claim 2 in which the compressed air storage chambers are open at the bottom to sea water.

4. The installation of claim 2 in which the wave energy collectors comprise buoyancy tanks mounted on the platform which move up and down relative to the platform with wave motion which drives the air compressors.

5. The installation of claim 4 in which the buoyancy tanks are ballasted with varying amounts of sea water to optimize energy collection from different heights of wave motion.

6. The installation of claim 2 in which the current collectors comprise turbines which are mounted tangential to the outside of the vertical tower.

7. The installation of claim 2 in which the compressed air in the storage chambers is maintained at about 8 atmospheres pressure.

8. The installation of claim 2 in which the bottom of the vertical tower is a minimum of 10 m above the sea bed.

9. The installation of claim 2 in which the electricity generation equipment comprises a generator and a transformer housed on the platform.

10. The installation of claim 2 in which the generator is integrated with the turbine at the bottom of the tower.

11. A method of generating electricity by anchoring an installation to the sea bed said installation comprising wave and/or sea current energy collectors driving air compressors, compressed air pipes taking compressed air to submerged storage chambers, expansion pipes up through which the air is released inducing a flow of water through a turbine chamber and a turbine driven by the induced flow to generate electricity.

12. A buoyancy hydro power storage installation comprising at least one compressor pumping air into storage, at least one pipe from the storage to the floor of an upright draft tube located in a body of water, through which the air is released inducing a flow of water through a turbine located in the floor of the draft tube to generate electricity.

13. The installation of claim 12 in which the compressed air is stored in an underground chamber.

14. The installation of claim 12 in which the compressed air is stored in a pressure vessel.

15. The installation of claim 12 in which the air is released at about 4 atmospheres pressure.
